(19) United States
(12) Patent Application Publication
(10) Pub. No.: US 2002/0107038 A1
(43) Pub. Date: Aug. 8, 2002

(54) Methods for transmitting and receiving short messages from a mobile terminal, in each case in a mobile radio network

(76) Inventor: Andreas Berg, Berlin (DE)

Correspondence Address: BELL, BOYD & LLOYD, LLC, P. O. BOX 1135, CHICAGO, IL, 60690-1135, US

(21) Appl. No.: 10/006,339

(22) Filed: Dec. 3, 2001

(30) Foreign Application Priority Data
Jan. 12, 2000 (DE) 100 59 647.9

(51) Int. Cl. H04Q 7/20

(52) U.S. Cl. 455/466; 455/412; 455/414

(57) ABSTRACT

A method for transmitting short messages from a mobile terminal and a method for receiving short messages from a mobile terminal, in each case in a mobile radio network, wherein the short message service center is a central point in the network for short messages and the approach to a solution which is acceptable for the network operator is a closed concept with respect to SMS, starting from the original terminal, or ending at the terminating terminal.

### BACKGROUND OF THE INVENTION

In the last few years, communication via mobile radio networks has become increasingly popular. On the one hand, asynchronous communication using what are referred to as short messages has become particularly widespread, despite the complicated operating procedures involved. On the other hand, the use of prepaid telephone cards in mobile terminals has become very popular with certain target groups; for example, with young people or with subscribers who do not make many telephone calls themselves but wish to be accessible at all times. However, it is not readily possible to combine the two popular features and the billing for short messages is carried out after a delay so that, in the past, many prepaid customers (or the service provider in question) have had a nasty surprise.

One possible way of implementing particular services in mobile radio networks is provided by the architecture of intelligent networks (defined in the standards ITU Q.1200 et seq., specifically ITU-T Q.1218, Interface Recommendation for Intelligent Network CS-1 (INAP)). In one special embodiment for GSM mobile radio networks there is what is referred to as the CAMEL (Customized applications for mobile radio network enhanced logic) standard, which is explained in more detail in a GSM standard. See GSM 09.02 Mobile Application Part (MAP) Specification, GSM 03.78 Customized Applications for Mobile Network Enhanced Logic (CAMEL)—Stage 2, and GSM 09.78 CAMEL Application Part (CAP) Specification—Phase 2.

Siemens, as a world market leader in intelligent networks, is often asked by network operators how IN (Intelligent Network) supports the Short Message Service SMS, particularly within the framework of the prepaid service PPS: in most networks, SMS is transparent; i.e., the switching subsystem SSS does not have a trigger mechanism which can inform IN of the transmission (Mobile Originating—MO) or reception (Mobile Terminating—MT) of a short message.

Although Siemens offers proprietary solutions (for example, from Switch Release SR8, the CAMEL Subscription Information for MOCs O-CSI will be used for a SMS trigger), these solutions function satisfactorily only in fully integrated Siemens networks. If a short message is sent in an overlay network in the area of an MSC (Mobile Switching Center) of another manufacturer, satisfactory functioning depends on whether or not the other manufacturer offers an SMS trigger.

For the near future, only a partial solution is known—but it would not be supported until CAMEL Phase 3: it contains an SMS MO trigger in the M-SSPs. For this purpose, an SMS-CSI (CAMEL Subscription Information) which includes the customary CSI data such as SCP (Service Control Point) address, Service Key, etc., is administered at the HLR (Home Location Register). A neat solution, but unfortunately it is too late and incomplete: an SMS MT trigger is included at the earliest in CAMEL Phase 4.

Previous solutions are proprietary (see above, SR8 SMS MO trigger via 0CSI) or what is referred to as “warm billing”: Billing systems of the network operator collect SMS tickets of an end user and send them “en bloc” via mass data interfaces to the “correct” SCP, where a “negative recharge” is carried out. The negative effects of this method found their way into the press when the costs for short messages escalated and end users at the SCP ran up large virtual debts. In such cases, the control of a prepaid system is proved ad adsurdum.

An object of the present invention is, therefore, to provide a solution for billing for the short message service, in particular in the case of prepaid billing, which avoids the abovementioned disadvantages.

### SUMMARY OF THE INVENTION

The short message service center (SMSC) is a central point in the network for short messages. An approach to a solution which is acceptable for the network operator should be a closed concept with respect to SMS, starting from the terminal, MO, or ending at the terminal, MT.

Accordingly, in an embodiment of the present, a method is provided for transmitting short messages from a mobile terminal in a mobile radio network, which includes the steps of: transmitting a short message from a mobile terminal; receiving the short message by a mobile switching center; forwarding the short message directly to a short message directly to a short message service center; staring an interrogation, via the short message service center, for a home location register; determining, during the interrogation, information required for delivery of the short message; and delivering the short message to a receiver with reference to the information.

In an embodiment, the method further includes the steps of: receiving, by the short message service center, an address of a service center responsible from the home location register; and starting a dialog, via the short message service center, to the service center responsible.

In a further embodiment of the present invention, a method is provided for receiving short messages from a mobile terminal in a mobile radio network, which includes the steps of: receiving a short message at a short message service center; staring an interrogation, via the short message service center, at a home location register which is responsible for the mobile terminal; determining, during the interrogation, information which is required for delivery of the short message; starting a dialog, via the short message service center, to a responsible service center, which is determined; and delivering the short message to a receiver by reference to the information.

In an embodiment, the method further includes the step of buffering the short message by the short message service center if the receiver cannot be reached.

In an embodiment, the method further includes the step of delivering the short message to a third-party terminal if a delivery address has been changed by the service center.

Advantages of the present invention:

The new solution does not locate the IN handling in a way which is distributed over the network at all the switching centers M-SSPs (Service Switching Point) or GSNs, but instead locates it centrally at the short message service centers SMSC.

The SMSC acts in such a way that adaptations to the other network elements are minimized, or do not occur at all.

Instead of “warm billing”, billing for short messages can be performed immediately.

In addition to the solution for MO short messages, there is also one for MT short messages.

The implementation of CAMEL Phases 3 and 4 is years too late for most network operators. They now need a network-compatible, high-speed solution.

The existing databases in the network, the HLRs, are used instead of implementing new databases again.

If the short messages arrive at an SMSC in the subscriber's own network, HPLMN (Home Publicland Mobile Network), a standardized protocol is not necessarily required between SMSC and SCP.

Additional features and advantages of the present invention are described in, and will be apparent from, the following Detailed Description of the Invention and the Figures.

### BRIEF DESCRIPTION OF THE FIGURES

FIG. 1 shows the transmission of an SMS (mobile originating, MO).

FIG. 2 shows the reception of an SMS (mobile terminating, MT).

The method which is currently known is illustrated in each case by dashed arrows, the method according to the present invention were arrows with unbroken lines.

### DETAILED DESCRIPTION OF THE INVENTION

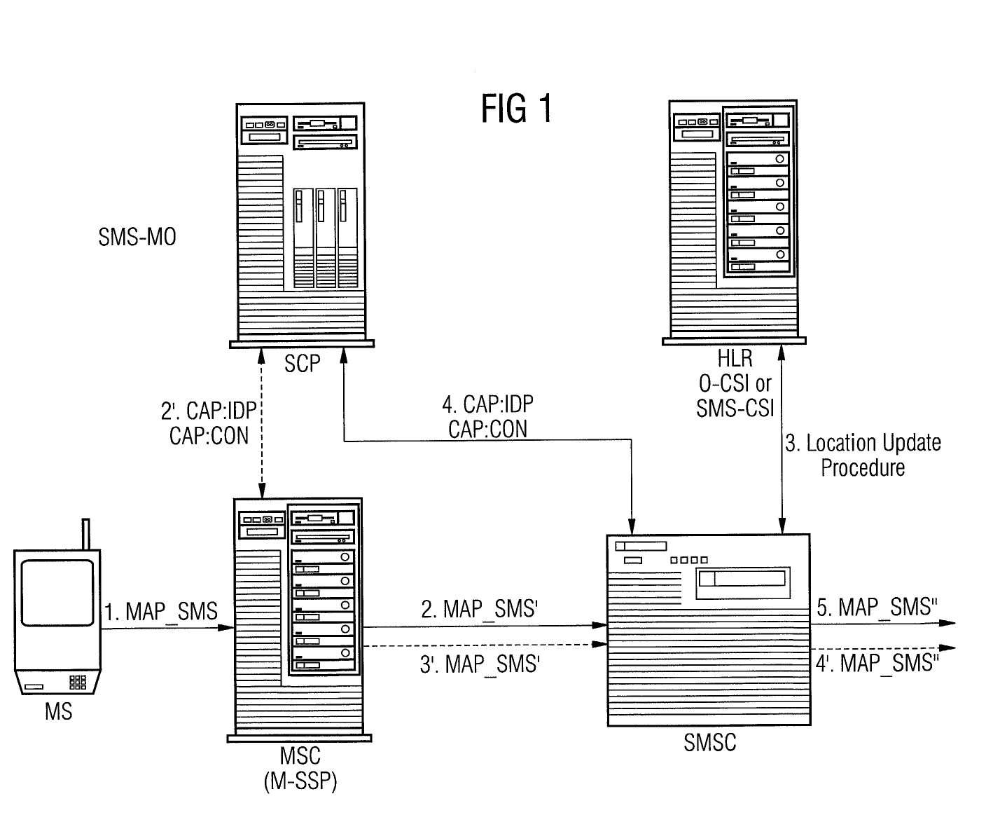

FIG. 1: SMS-MO:

In the method in CAMEL Phase 3 which is already known, the transmission of a short message SMS-MO from a terminal MS (Mobile Station), 1. MAP_SMS, (MAP—Mobile Application Part), initiates a CAP3 (CAMEL Application Part) dialog (2′. CAP:IDP, CAP:CON) (IDP—Initial Detection Point) to the service center SCP which is specified in the SMS-CSI. After termination of the dialog, the mobile switching center forwards the short message to the short message service center SMSC (3′. MAP_SMS′) which, in turn, attempts to deliver the short message (4′. MAP_SMS″). (Similar to: SR8, V6.1)

In contrast, in the method according to the present invention, the CAP dialog at the mobile switching center MSC is suppressed (either because the MSC does not have an SSP or because no SMS-CSI is assigned to the subscriber) and the short message is forwarded directly to the short message service center SMSC (2. MAP_SMS′). The SMSC requires for the rest of the method the information as to whether the SMS has been transmitted by an IN subscriber and, if that is the case, the information as to which service center SCP a CAP dialog will be started at. For this purpose, the GSM atypically carries out a procedure with respect to the HLR of the subscriber, with which procedure the SMSC receives a suitable CSI (CAMEL Subscription Information), (3): Either the “Location Update” procedure (O-CSI, GPRS-CSI, possibly SMS-CSI), (GPRS—General Packet Radio System), or the “HLR Interrogation” (T-CSI, VT-CSI, GPRS-CSI).

The SCP address from the CSI which is received can then be used to start a dialog with the SCP (4), which uses CAP, INAP (Intelligent Network Application Part) or even TCP/IP as protocol. After the termination of the dialog, the SMSC attempts to deliver the SMS on a standard basis, 5. MAP_SMS″.

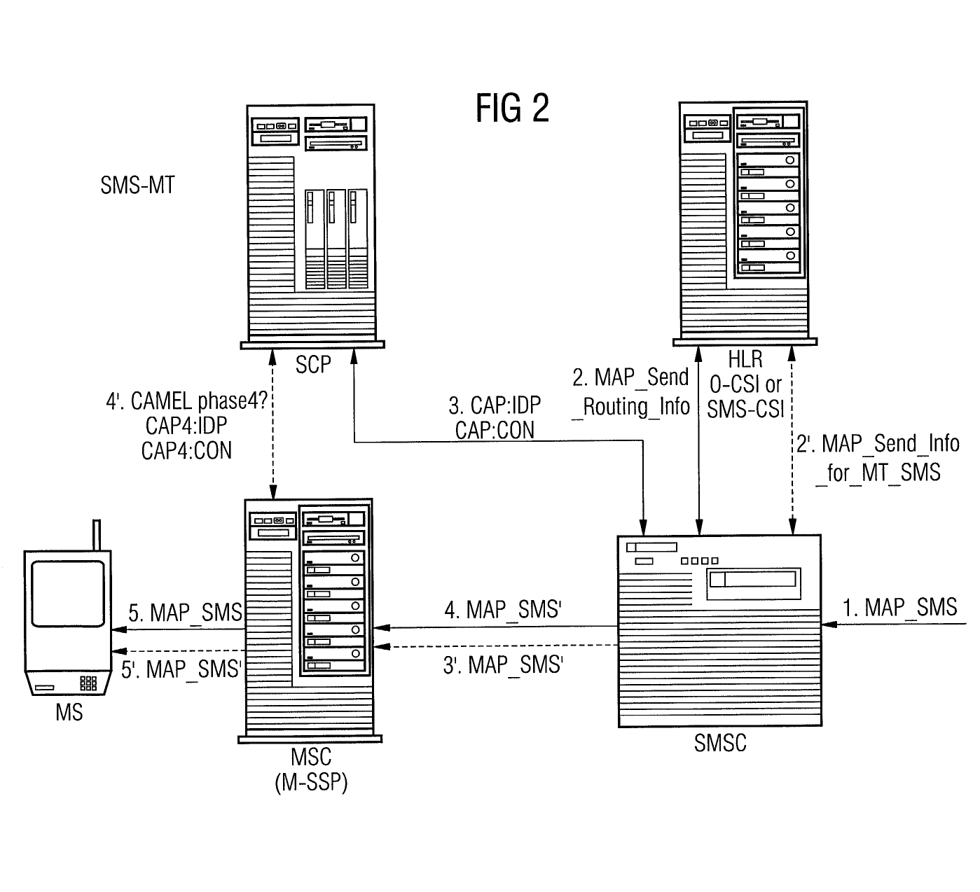

FIG. 2: SMS-MT:

After a short message, 1. MAP_SMS, has been received, an SMSC interrogates the HLR (2′, MAP_Send_Info_for_MT SMS) which is responsible for the receiver (also referred to as B party) in order to be able to deliver (3′. MAP_SMS) the short message to the switching center MSC. Starting from CAMEL Phase 4 (or later), a dialog (4′) could be opened to the service center SCP, which is specified in an SMS′-CSI (CAP4:IDP, CAP4:CON) which is to be standardized. After termination of the dialog, the MSC attempts to deliver (5′: MAP_SMS) the short message.

In the method for which we are making an application, an MT-specific HLR interrogation (2. MAP_Send-Routing_Info), which informs the SMSC of the following CAMEL Subscription Information CSIs: T-CSI, VT-CSI, GPRS-CSI, is carried out instead of the SMS-specific HLR interrogation. Using one of these CSIs, the CAP, INAP or even TCP/IP (Transport Control Protocol/Interact Protocol) dialog (3. CAP:IDP, CAP:CON) with the SCP is started.

After termination of the dialog, the short message service center SMSC attempts to deliver the SMS on a standard basis, i.e. in accordance with the customary SMSC method; for example, storage of the SMS if the B party cannot be accessed or even diversion to a C party if the SCP has changed the delivery address, which results in a further interrogation.

Although the present invention has been described with referenced to specific embodiments, those of skill in the art will recognize that changes may be made thereto without departing from the spirit and scope of the invention as set forth in the hereafter appended claims.

1. A method for transmitting short messages from a mobile terminal in a mobile radio network, the method comprising the steps of:
transmitting a short message from a mobile terminal;
receiving the short message by a mobile switching center;
forwarding the short message directly to a short message service center;
starting an interrogation, via the short message service center, for a home location register;
determining, during the interrogation, information required for delivery of the short message; and
determining the short message to a receiver with reference to the information.

2. A method for transmitting short messages from a mobile terminal in a mobile radio network as claimed in claim 1, the method further comprising the steps of:
receiving, by the short message service center, an address of a service center responsible from the home location register; and
starting a dialog, via the short message service center, to the service center responsible.

3. A method for receiving short messages from a mobile terminal in a mobile radio network, the method comprising the steps of:
receiving a short message at a short message service center;
starting an interrogation, via the short message service center, at a home location register which is responsible for the mobile terminal;
determining, during the interrogation, information which is required for delivery of the short message;
starting a dialog, via the short message service center, to a responsible service center which is determined; and
delivering the short message to a receiver by reference to the information.

4. A method for receiving short messages from a mobile terminal in a mobile radio network as claimed in claim 3, the method further comprising the step of buffering the short message by the short message service center if the receiver cannot be reached.

5. A method for receiving short messages from a mobile terminal in a mobile radio network as claimed in claim 3, the method further comprising the step of delivering the short message to a third-party terminal if a delivery address has been changed by the responsible service center.
